(19) United States
(12) Patent Application Publication
(10) Pub. No.: US 2025/0238803 A1
(43) Pub. Date: Jul. 24, 2025

(54) SELF-HEALING TECHNOLOGY FOR COMPUTER SERVICES OF AN IT INFRASTRUCTURE

(71) Applicant: The PNC Financial Services Group, Inc., Pittsburgh, PA (US)

(72) Inventors: Marcel Schachter, Pittsburgh, PA (US); Surjeet Singh, North Royalton, OH (US); Matt Rich, Parma, OH (US); Gabriela H. Smith, Pittsburgh, PA (US)

(21) Appl. No.: 19/033,395

(22) Filed: Jan. 21, 2025

Related U.S. Application Data
(60) Provisional application No. 63/622,703, filed on Jan. 19, 2024.

(51) Int. Cl. G06Q 30/015

(52) U.S. Cl. CPC G06Q 30/015

(57) ABSTRACT

A self-healing system comprising a monitoring tool to detect incidents within a service, an alerting system coupled to the monitoring tool, a ticketing system coupled to the alerting system, and a self-healing solution configured to execute a solution to the incident. The alerting system is configured to create an event based on the incident. The ticketing system is configured to create a ticket based on a status of the incident.

### PRIORITY CLAIM

The present application claims priority to U.S. provisional patent application Ser. No. 63/622,703, filed Jan. 19, 2024, which is incorporated herein by reference in its entirety.

### BACKGROUND

In computer networks, observability is the ability to collect data about programs' execution, modules' internal states, and the communication among components. To improve observability, software engineers use a wide range of logging and tracing techniques to gather telemetry information, and tools to analyze and use it. Observability is foundational to site reliability engineering, as it is the first step in triaging a service outage. IT departments for enterprise computer systems often also employ IT ticketing systems, which are used to track IT service requests, events, incidents and alerts that might require additional action by the IT department.

### SUMMARY

In one general aspect, the present invention relates to a self-healing systems and methods for computer services and processes of an IT infrastructure, such as for the computer network of an enterprise. The method, according to various embodiments, can comprising detecting, by a monitoring tool, an incident on a server of the enterprise computer network. After the incident is detected, the monitoring tool can wait a first delay period. After the first delay period, the monitoring tool can determine whether the incident has not been resolved. If, after the first delay period the incident is not resolved, an alerting system, can create an event based on the incident. The alerting system can then wait a second delay period. After the second delay period, the alerting system can determine whether the incident has not been resolved. If not, a ticketing system can create a ticket based on the determination that the incident is not resolved. Then, a self-healing solution can execute a solution based on the incident, upon which the self-healing solution can determine a result of executing the solution. Then, the ticketing system can update the ticket based on the result of the executing the solution. Then, the alerting system can update the event based on the result of executing the solution.

In various embodiments, such a self-healing tool can eliminate human intervention and preclude investigation of each occurrence. This can save an IT department over 10 minutes for each incident, thereby allowing the IT department to focus on actual issues that do not resolve or not resolve easily. These and other benefits that can be realized through various embodiments of the present invention will be apparent from the description that follows.

### BRIEF DESCRIPTION OF THE FIGURES

Unless specified otherwise, the accompanying drawings illustrate aspects of the innovations described herein. Referring to the drawings, wherein like numerals refer to like parts throughout the several views and this specification, several embodiments of presently disclosed principles are illustrated by way of example, and not by way of limitation. The drawings are not intended to be to scale. A more complete understanding of the disclosure may be realized by reference to the accompanying drawings.

FIG. 1 is a diagram of a self-healing tool, according to various embodiments of the present invention.

FIG. 2 illustrates a high priority incident timeline, according to various embodiments of the present invention.

FIG. 3 illustrates a low priority incident timeline, according to various embodiment of this disclosure.

FIG. 4 illustrates a method of operating the self-healing tool of FIG. 1, according to various embodiments of the present invention.

### DETAILED DESCRIPTION

This disclosure relates to self-healing of computer processes run by an enterprise on or with an enterprise computer network. Some issues that arise in the enterprise's computer processes can be resolved by restarting the process. In general, aspects of the present invention relate to a self-healing system configured to recognize an issue in one of the enterprise's computer processes, create a ticket about the issue, identify that the process is a target for restart, update the ticket, and wait for the restart to complete. If the service restarts successfully the system can automatically close the service incident ticket with specified documentation of the resolution. In some embodiments, a software observability platform, such as from Dynatrace, can be used to identify a problem; an IT ticketing system, such as from ServiceNow, can be used to create a ticket; and an orchestration engine, such as from TrueSight, can run a script (TrueSight uses an Ansible script) based on the identified problem, where script can restart the service or the server where the problem was identified. Then, the orchestration engine can update, for example, the ServiceNow incident. The self-healing tool, in various embodiments, confirms that the issue did not reoccur after the restart, and then closes the ServiceNow incident. The specific restart sequence can account, in various embodiments, for the fact that some services rely on multiple services across multiple servers.

For many incidents (blips), a problem in a process occurs and the software observability platform (e.g., Dynatrace) identifies the problem, but the problem self recovers without any input. Utilizing a table that lists the incidents that recover without intervention allows the system to identify these incidents from actionable items, i.e., ones that do not self-recover and that require some form of action as described herein. Waiting for self-recovery can avoid creating the ServiceNow ticket, thereby removing human intervention from having to resolve the issue as a ServiceNow ticket ordinarily requires a person to update and resolve the ticket. For example, in various embodiments of the present invention, TrueSight creates an incident (through TrueSight orchestration); the system waits for a period of delay (e.g., 10 minutes); and in the delay period TrueSight observes whether the incident has self-recovered. If the incident has not recovered, TrueSight creates the incident and sends the incident to ServiceNow to create a ticket. If the incident has recovered, it does not create the ServiceNow ticket. By not creating the ServiceNow ticket, a person does not have to update the ticket for a self-resolved issue. The orchestration engine (e.g., TrueSight) can store data about the event in memory of the orchestration engine or elsewhere in the enterprise network.

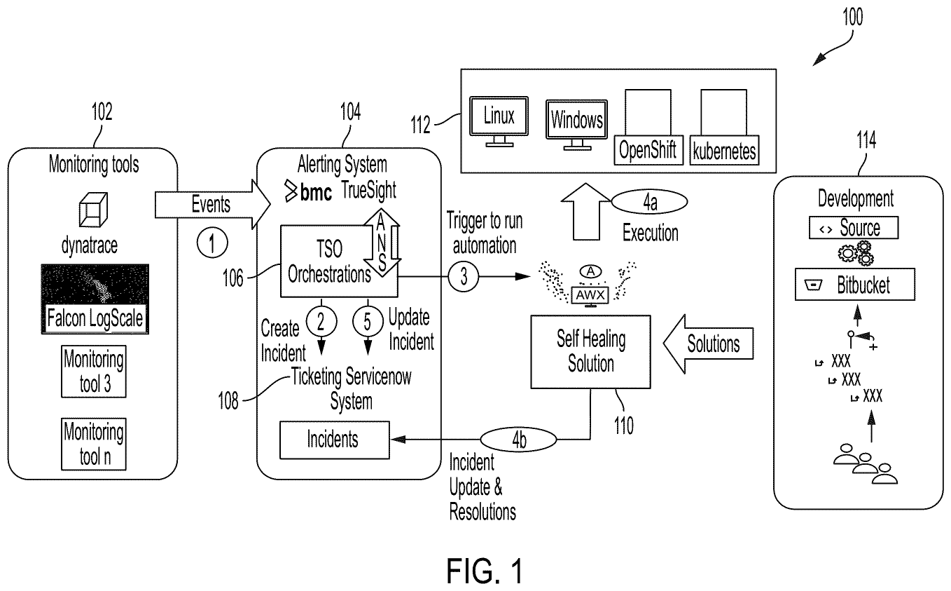

With reference now to the figures, FIG. 1 depicts a self-healing tool 100, according to various embodiments of the present invention. The self-healing tool 100 can comprise, as shown in the example of FIG. 1, a monitoring tool 102, an alerting system 104, a ticketing system 108, and a self-healing solution 110. The self-healing tool 100 is coupled to a service or server 112. The monitoring tool 102, the alerting system 104, the ticketing system 108, and the self-healing solution 110 are implemented by computer systems or servers of the enterprise computer system. The computer systems may comprise a processor(s) and a memory(ies). In some embodiments, the system comprises a development tool 114. The memory(ies) can store software that, when executed by the processor(s) of the computer systems, perform the processes, functions and operations of the monitoring tool 102, the alerting system 104, the ticketing system 108, the self-healing solution 110, and the development tool 114.

The monitoring tool 102 detects an incident with respect to a service 112 or application of the enterprise. The incidents can include, but are not limited to, Java Database Connectivity (JDBC) connection pool increase, file description error, or any type of incident based on coded criteria which can change as needed. The monitoring tool 102 is implemented by software run by a computer system. The monitoring tool 102 can be implemented via Software as a Service (SaaS), where customers access the monitoring tool 102 through a web browser. The monitoring tool 102 could also be implemented as part of a on-premises deployment. The monitoring tool 102 can run, for example, in a cloud computing environment. To handle the massive amounts of data collected and processed, the monitoring tool 102 can rely on high-performance computing (HPC) technologies, including powerful servers, high-speed networks, and specialized hardware (like GPUs) for AI/ML processing. It can also run on a distributed computer system to ensure high availability, fault tolerance, and scalability. This can involve distributing components across multiple servers and data centers. To store and manage the vast amounts of data collected, the monitoring tool can utilize high-performance databases, such as NoSQL databases and time-series databases. The monitoring tool 102 reports the detected incident to the alerting system 104.

In one embodiment, the monitoring tool 102 utilizes a delay period, which can be a period of time that the monitoring tool 102 waits before reporting the incident to the alerting system 104. After the delay period has elapsed, the monitoring tool 102 determines whether the incident has been resolved. The monitoring tool 102 reports the incident to the alerting system 104 when the delay period has elapsed and the incident is not resolved. If the incident is resolved, the monitoring tool 102 does not report the incident to the alerting system 104. The delay period can be any suitable period of time that is long enough so that incidents have time to resolve, but not so long that incidents are not reported in a timely manner. For example, the delay period could be 10 minutes or something similar.

The monitoring tool 102 may implemented with Dynatrace, LogScale, or other similar monitoring tools. In some embodiments, multiple monitoring tools may be used in combination. The monitoring tool 102 reports incidents to the computerized alerting system 104.

The alerting system 104 creates an event based on the incident received from the monitoring tool 102. The alerting system 104 can be implemented with a TrueSight alerting orchestration system or other similar, suitable alerting systems. The alerting system 104 can store the events and the outcomes in memory thereof. The alerting system 104 can run, or be deployed, on an on-premises network of the enterprise, in a cloud computing environment for the enterprise, or in a hybrid cloud deployment involving a mix of physical servers within the enterprise's network and virtual servers in the cloud, all of which utilize servers. Applications and data can be distributed across servers for the alerting system 104 based on specific needs of the enterprise.

In some embodiments, the alerting system 104 implements an additional delay period before creating an alert. The additional delay period can be a period of time that the alerting system 104 waits before determining whether the incident has been resolved and the event is sent to the ticketing system 108. After the additional delay period has elapsed, the alerting system 104 can determine whether the incident has resolved. If the additional delay period has elapsed and the incident is not resolved, the alerting system 104 can send an event for the incident to the ticketing system 108. If the incident has been resolved within the additional delay period, the alerting system 104, in various embodiments, does not send the event to the ticketing system 108.

The alerting system 104 may comprise a software module 106 for, when executed by the computers of the alerting system 104, determining the type of incident. In various embodiments, the module 106 stores a table that comprises the types of incidents and wait times corresponding to each type of incident in the table. In some embodiments, the additional delay period is variable and depends on the corresponding wait time for the type of incident. The alerting system 104 can be configured to determine the type of incident and the corresponding wait time for the incident. The alerting system 104 waits for the corresponding wait time based on the incident type. After the corresponding wait time has elapsed, the alerting system 104 determines if the incident is resolved. If the additional delay period has elapsed and the incident is not resolved, the event is sent to the ticketing system 108. If the incident has been resolved within the additional delay period, the event is not sent to the ticketing system 108.

The corresponding wait times in the table are based on the incident. These wait times may be pre-defined in the table used by the alerting system 104. In other embodiments, the wait time may be updated based on the events and results stored in memory.

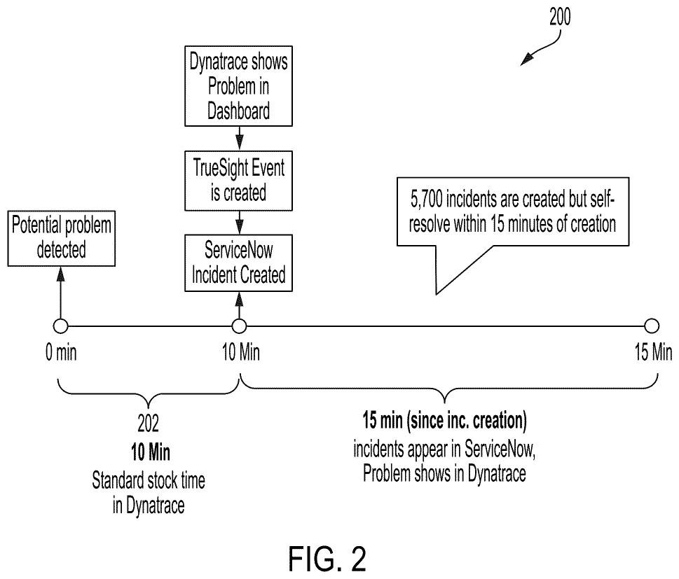

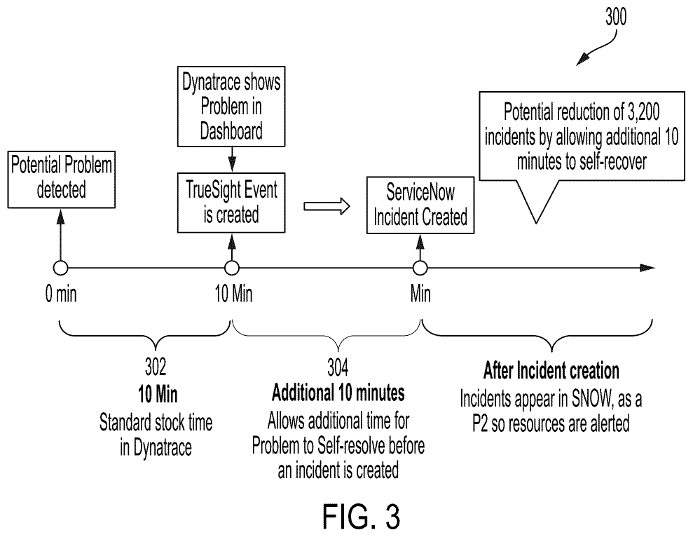

In some embodiments, the table also includes a priority level for each type of incident in the table. The priority level may correspond to a high priority and a low priority. The high priority incidents may not have an additional wait time and correspond to the timeline of the example of FIG. 2. The low priority incidents may have an additional wait time and correspond to the timeline of the example FIG. 3.

The ticketing system 108 may be implemented with a cloud-based platform to, for example, manage IT incidents, problems, changes and assets of the enterprise's IT system. The ticketing system 108 can integrate, such as via APIs, with the alerting system 104 to receive and log incidents from the alerting system 104. The ticketing system's cloud-based system can comprise data centers and servers to host and deliver its platform and services.

FIG. 2 illustrates a high priority incident timeline 200, according to an embodiment of this disclosure. The high priority incident timeline 200 includes the first delay period 202. The first delay period 202 corresponds the delay period stored within, and used by, the monitoring tool 102 (e.g., DynaTrace). After the first delay period 202, the alerting system 104 (e.g., TrueSight) creates the alert and the ticketing system 108 (e.g., ServiceNow) creates the ticket.

FIG. 3 illustrates a low priority incident timeline 300, according to an embodiment of this disclosure. The low priority incident timeline 300 includes the first delay period 302 and the second delay period 304. The first delay period 302 corresponds the delay period stored within, and used by, the monitoring tool 102. After the first delay period 302, the alerting system 104 (TrueSight) creates the alert. The second delay period 304 corresponds to the additional delay period stored in, and used by, the alerting system 104. In the illustrated embodiment, the additional delay period 304 is also 10 minutes, although different additional delay periods could be used and the duration of the additional delay period does not need to match the duration of the first delay period 302. After the second delay period 304, the ticketing system 108 creates the ticket if the incident is not resolved within the second delay.

Referring back now to FIG. 1, in some embodiments, the high priority incidents may be scheduled to be resolved before the low priority incidents. The alerting system 104 sends the event and the priority to the self-healing solution 110. The self-healing solution 110 resolves the high priority incidents before low priority incidents.

The alerting system 104 is communicatively coupled to the ticketing system 108, such as via APIs. The alerting system 104 sends the event to the ticketing system 108. The ticketing system 108 receives the event from the alerting system 104. The ticketing system 108 creates and stores a ticket. For example, the ticketing system 108 can include ServiceNow or other similar ticketing systems. The ticketing system 108 stores all incidents that have not been resolved.

The alerting system 104 is also coupled communicatively to the self-healing solution 110, such as via APIs. The alerting system 104 sends the event to the self-healing solution 110 if the incident is not resolved within the delay period or the delay period and the additional delay period. In some embodiments, the alerting system 104 waits for the additional period of time to have elapsed before sending the event to the self-healing solution 110.

The self-healing solution 110 may be implemented with a computer device programmed via software to perform its self-healing operations. The self-healing solution 110 may include a script code to fix the identified incident. The self-healing solution 110, for example, runs the script code to fix the identified incident. In one embodiment, the self-healing solution 110 utilizes an Ansible script code run on an Ansible tower, Amazon Web Server, or Redhat server. An Ansible script is a component of an Ansible playbook, which is a collection of scripts that define tasks for managing a system configuration. Playbooks are preferably written in YAML, a human-readable language, and contain a collection of tasks that Ansible executes on target hosts. The task can include, in this case, fixing the identified incident. An Ansible tower can be a web-based application that provides a centralized platform for managing and orchestrating Ansible automation.

The self-healing solution 110 can store an incident table in a memory. The incident table includes a plurality of events. The table can include the event and a solution to the event. The self-healing solution 110 determines whether the incident is on pre-defined incident table. If the incident is listed in the table, the self-healing solution 110 begins to execute the solution.

The self-healing solution 110 can execute the solution on the server or service 112 that has the incident. The solution may be to restart the server or service 112, an API call to run orchestration or trigger a bot, to reduce or increase memory based on error, to kill a process on a server, or any type of solution that can be coded. The server or service 112 can include Linux, Windows, OpenShift, Kubernetes, or other types of services.

After the solution has been executed, the self-healing solution 110 can determine that the incident did not recur after the solution, in which case the self-healing solution 110 sends an update on the incident to the alerting system 104. The ticketing system 108 sends an update to the alerting system 104. The ticketing system 108 stores the event and corresponding data in memory. The data may include, how long the incident took to resolve, whether the solution resolved the problem, or whether the incident self-resolved during a delay period.

The self-healing tool 100 may comprise the development tools 114. The development tools 114 may include Bitbucket, Git-based development platform, or other similar software development tools with version control capabilities. The self-healing solution 110 is stored and developed on the development tool 114.

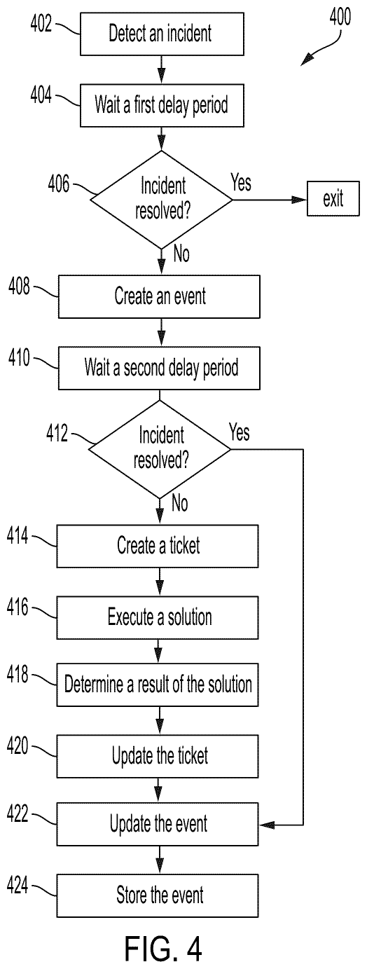

FIG. 4 illustrates a method 400 of operating the self-healing tool 100 of FIG. 1, according to an embodiment of this disclosure. In the illustrated embodiment, the monitoring tool 102 detects at step 402 an incident on the service or server 112. The monitoring tool 102 waits at step 404 for a first delay period. After the first delay period, the monitoring tool 102 determines at step 406 whether the incident has been resolved. If the incident is resolved within the first delay period, the method 400 follows the Yes path and the incident is not reported to the alerting system 104. If the incident is not resolved within the first delay period, the method 400 follows the No path and the incident is reported to the alerting system 104.

After the first delay period and the determination that the incident is not resolved, the alerting system 104 creates at step 408 an event based on the incident. The alerting system 104 waits at step 410 for a second delay period. After the second delay period has elapsed, the alerting system 104 determines at step 412 whether the incident has been resolved. If the incident has been resolved, the method 400 follows the Yes path and the alerting system 104 updates at step 422 the event. If the incident has not been resolved, the method 400 follows the No path and the event is sent to the ticketing system.

The ticketing system 108 creates at step 414 a ticket based on the determination that the incident has not been resolved. The alerting system 104 also sends the incident to the self-healing solution 110 if the incident is not resolved. The self-healing solution 110 executes at step 416 a solution based on the incident. The self-healing solution 110 determines at step 418 a result of the execution of the solution. The result may be at least one of whether the incident has been resolved or recurred after the execution of the solution.

The self-healing solution 110 sends the determination to the alerting system 104 and the ticketing system 108. The ticketing system 108 updates at step 420 the ticket based on the result. If the solution resolved the incident, the ticketing system 108 marks the event as resolved. If the solution is not resolved, the ticketing system 108 marks the event as unresolved. The alerting system 104 updates at step 422 the event based on the result of the execution of the solution. The alerting system 104 stores at step 424 the event and data related to the event in memory.

The software tools, systems and modules 102, 104, 106, 108, 110, 114, for the various computer systems described herein and other computer functions described herein may be implemented in computer software using any suitable computer programming language such as .NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

In one general aspect, therefore, the present invention is directed to a self-healing system for an enterprise's IT system. In various embodiments, the self-healing system comprises a computer-implemented, software-based monitoring tool to detect an incident within a service of the enterprise's IT system. The self-healing system further comprises a computer-implemented, software-based alerting system coupled to the monitoring tool, where the alerting system is configured to create an event based on the incident. The self-healing system further comprises a computer-implemented, software-based ticketing system coupled to the alerting system, where the ticketing system is configured to create a ticket based on a status of the incident. And the self-healing system further comprises a computer-implemented, software-based self-healing solution configured to execute a solution to the incident.

In various implementations, the monitoring tool, the alerting system, the ticketing system, and the self-healing solution are implemented by one or more computer servers of an enterprise computer system. Additionally, the enterprise computer system can comprise an on-premises computer network and/or a cloud computing network. In various implementations, the monitoring tool runs in a cloud computing environment. The monitoring tool can comprises a NoSQL database or a time-series database.

In various implementations, the ticketing system is integrated via APIs with the alerting system to receive and log incidents from the alerting system.

In various implementations, the self-healing solution utilizes an Ansible script code run on server.

In various implementations, the incident comprises at least one of Java Database Connectivity (JDBC) connection pool increase, or file description error.

In various implementations, the monitoring tool is configured to report the detected incident to the alerting system.

In various implementations, the monitoring tool is configured to store a delay period, wherein the delay period is a period of time that the monitoring tool is configured to wait before reporting the incident to the alerting system. After the delay period has elapsed, the monitoring tool can determine whether the incident has been resolved, and based on the delay period elapsing and the incident not being resolved, the monitoring tool is configured to report the incident to the alerting system or based on the delay period elapsing and the incident being resolved, the incident is not reported to the alerting system. Still further, the alerting system can be configured to implement an additional delay period before creating an alert, where the additional delay period comprises a period of time that the alerting system waits before determining whether the incident has been resolved and the event is sent to the ticketing system. Still further, after the additional delay period has elapsed, the alerting system can be configured to determine whether the incident has resolved, based on the additional delay period elapsing and the incident is not resolved, the alerting system is configured to send an event for the incident to the ticketing system or based on the incident being resolved within the additional delay period, the alerting system is configured to not send the event to the ticketing system.

In various implementations, the alerting system comprises a module to determine a type of the incident, wherein each type of incident has a different wait time or priority level.

In various implementations, the self-healing solution is configured to determine whether the incident recurred after the solution.

In various implementations, the alerting system is configured to send the event to the ticketing system.

In another general aspect, the present invention is directed to a self-healing method. The method comprises the steps of detecting, by a monitoring tool, an incident on a server; determining, by the monitoring tool, the incident has not been resolved; creating, by an alerting system, an event based on the incident; determining, by the alerting system, the incident has not been resolved; creating, by a ticketing system, a ticket based on the determination that the incident is not resolved; and executing, by a self-healing solution, a solution based on the incident.

In various implementations, the method further comprises waiting, by the monitoring tool, a first delay period, where determining the incident has not been resolved after the first delay period has elapsed. The method can further comprise waiting, by the alerting system, a second delay period, where determining the incident has not been resolved after the second delay period has elapsed.

In various implementations, the method further comprises determining, by the self-healing solution, a result of executing the solution. The method can further comprise updating, by the ticketing system, the ticket based on the result of the executing the solution. The method can further comprise updating, by the alerting system, the event based on the result of executing the solution.

In various implementations, the method can further comprise reporting, by the monitoring tool, the detected incident to the alerting system.

In various implementations, the method can further comprise determining, by the alerting system, a type of the incident, wherein each type of incident has a different wait time or priority level.

In various implementations, the method can further comprise storing, by the monitoring tool, a delay period, wherein the delay period is a period of time that the monitoring tool is configured to wait before reporting the incident to the alerting system.

The various computer systems described herein may comprise one or more processors and one or more data storage or computer memory units. The memory, which may comprise primary (memory directly accessible by the processor, such as RAM, processor registers and/or processor cache) and/or secondary (memory not directly accessible by the processor, such as ROM, flash, HDD, etc.) data storage, stores computer instruction or software to be executed by the processor(s). In particular, the memory may store the software for the various software modules and tools described herein. When the processor(s) executes the software, the processor(s) perform the corresponding functions described above. The processor(s) may include single or multicore CPUs, for example. The processors(s) may also comprise heterogeneous multicore processor(s) that include, for example, CPU, GPU and/or DSP cores. The software code for the tools and modules may be written suitable programming languages as described above.

Having thus described several aspects and embodiments of the technology of this application, it is to be appreciated that various alterations, modifications, and improvements will readily occur to those of ordinary skill in the art. Such alterations, modifications, and improvements are intended to be within the scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A self-healing system for an enterprise's IT system, the self-healing system comprising:
a computer-implemented, software-based monitoring tool to detect an incident within a service of the enterprise's IT system;
a computer-implemented, software-based alerting system coupled to the monitoring tool, wherein the alerting system is configured to create an event based on the incident;
a computer-implemented, software-based ticketing system coupled to the alerting system, wherein the ticketing system is configured to create a ticket based on a status of the incident; and
a computer-implemented, software-based self-healing solution configured to execute a solution to the incident.

2. The self-healing system of claim 1, wherein the monitoring tool, the alerting system, the ticketing system, and the self-healing solution are implemented by one or more computer servers of an enterprise computer system.

3. The self-healing system of claim 2, wherein the enterprise computer system comprises an on-premises computer network.

4. The self-healing system of claim 2, wherein the enterprise computer system comprises a cloud computing network.

5. The self-healing system of claim 1, wherein the monitoring tool runs in a cloud computing environment.

6. The self-healing system of claim 1, wherein the monitoring tool comprises a NoSQL database.

7. The self-healing system of claim 1, wherein the monitoring tool comprises a time-series database.

8. The self-healing system of claim 2, wherein the ticketing system is integrated via APIs with the alerting system to receive and log incidents from the alerting system.

9. The self-healing system of claim 1, wherein the self-healing solution utilizes an Ansible script code run on server.

10. The self-healing system of claim 1, wherein the incident comprises at least one of Java Database Connectivity (JDBC) connection pool increase, or file description error.

11. The self-healing system of claim 1, wherein the monitoring tool is configured to report the detected incident to the alerting system.

12. The self-healing system of claim 1, wherein the monitoring tool is configured to store a delay period, wherein the delay period is a period of time that the monitoring tool is configured to wait before reporting the incident to the alerting system.

13. The self-healing system of claim 12, wherein after the delay period has elapsed, the monitoring tool is configured to determine whether the incident has been resolved, and based on the delay period elapsing and the incident not being resolved, the monitoring tool is configured to report the incident to the alerting system or based on the delay period elapsing and the incident being resolved, the incident is not reported to the alerting system.

14. The self-healing system of claim 13, wherein the alerting system is configured to implement an additional delay period before creating an alert, wherein the additional delay period comprises a period of time that the alerting system waits before determining whether the incident has been resolved and the event is sent to the ticketing system.

15. The self-healing system of claim 14, wherein after the additional delay period has elapsed, the alerting system is configured to determine whether the incident has resolved, based on the additional delay period elapsing and the incident is not resolved, the alerting system is configured to send an event for the incident to the ticketing system or based on the incident being resolved within the additional delay period, the alerting system is configured to not send the event to the ticketing system.

16. The self-healing system of claim 1, wherein the alerting system comprises a module to determine a type of the incident, wherein each type of incident has a different wait time or priority level.

17. The self-healing system of claim 1, the self-healing solution is configured to determine whether the incident recurred after the solution.

18. The self-healing system of claim 2, wherein the alerting system is configured to send the event to the ticketing system.

19. A self-healing method comprising:
detecting, by a monitoring tool, an incident on a server;
determining, by the monitoring tool, the incident has not been resolved;
creating, by an alerting system, an event based on the incident;
determining, by the alerting system, the incident has not been resolved;
creating, by a ticketing system, a ticket based on the determination that the incident is not resolved; and
executing, by a self-healing solution, a solution based on the incident.

20. The self-healing method of claim 19, further comprising:
waiting, by the monitoring tool, a first delay period; and
wherein determining the incident has not been resolved after the first delay period has elapsed.

21. The self-healing method of claim 20, further comprising:
waiting, by the alerting system, a second delay period; and
wherein determining the incident has not been resolved after the second delay period has elapsed.

22. The self-healing method of claim 19, further comprising determining, by the self-healing solution, a result of executing the solution.

23. The self-healing method of claim 22, further comprising updating, by the ticketing system, the ticket based on the result of the executing the solution.

24. The self-healing method of claim 23, further comprising updating, by the alerting system, the event based on the result of executing the solution.

25. The self-healing method of claim 19, further comprising reporting, by the monitoring tool, the detected incident to the alerting system.

26. The self-healing method of claim 19, further comprising determining, by the alerting system, a type of the incident, wherein each type of incident has a different wait time or priority level.

27. The self-healing method of claim 19, further comprising storing, by the monitoring tool, a delay period, wherein the delay period is a period of time that the monitoring tool is configured to wait before reporting the incident to the alerting system.

28. A self-healing method comprising:
detecting, by a monitoring tool, an incident on a server;
waiting, by the monitoring tool, a first delay period;
after the first delay period, determining, by the monitoring tool, the incident has not been resolved;
after the first delay period, creating, by an alerting system, an event based on the incident;
waiting, by the alerting system, a second delay period;
after the second delay period, determining, by the alerting system, the incident has not been resolved;
creating, by a ticketing system, a ticket based on the determination that the incident is not resolved;
executing, by a self-healing solution, a solution based on the incident;
determining, by the self-healing solution, a result of executing the solution;
updating, by the ticketing system, the ticket based on the result of the executing the solution; and
updating, by the alerting system, the event based on the result of executing the solution.
